(19) United States
(12) Patent Application Publication
(10) Pub. No.: US 2026/0178275 A1
(43) Pub. Date: Jun. 25, 2026

(54) TRANSFORM BLOCK FLOATING POINT VALUES TO OTHER BLOCK FLOATING POINT FORMATS

(71) Applicant: XILINX, INC., San Jose, CA (US)

(72) Inventors: Juan J. NOGUERA SERRA, San Jose, CA (US); Baris OZGUL, Dublin (IE); Francisco BARAT QUESADA, Erembodegem (BE); Luc DE COSTER, Aalst (BE); Pedro Miguel Parola DUARTE, Skerries (IE)

(21) Appl. No.: 18/990,714

(22) Filed: Dec. 20, 2024

(51) Int. Cl. G06F 7/483

(52) U.S. Cl. CPC G06F 7/483

(57) ABSTRACT

Embodiments herein describe an artificial intelligence (AI) engine including a register file including a block floating point configured to be converted to a block size that aligns with hardware capabilities by dividing the block floating point into multiple sub-blocks and replicating an exponent of the block floating point for each of the multiple sub-blocks. In one example, the block floating point includes 32 elements and the multiple sub-blocks are 4 sub-blocks with 8 elements each. In another example, the block floating point includes 32 elements and the multiple sub-blocks are 2 sub-blocks with 16 elements each.

### TECHNICAL FIELD

Examples of the present disclosure generally relate to artificial intelligence (AI) engines, and, in particular, to an AI engine for transforming block floating point values to other block floating point formats.

### BACKGROUND

Block floating-point (BFP) representations are a hybrid approach to numerical data encoding, designed to balance the precision of floating-point formats with the memory efficiency of fixed-point arithmetic. Traditional floating-point formats store each value with its own sign, exponent, and mantissa, offering high precision and a large dynamic range. However, this approach consumes significant memory and processing resources, especially when handling large data sets or embedded systems with limited storage. BFP formats address this limitation by grouping a set of values into blocks that share a common exponent. Each value within the block is represented by an integer (mantissa) and a shared exponent, which reduces memory usage and computation time while maintaining a reasonable level of precision across the block.

By using a shared exponent, BFP reduces the number of exponents needed, which lowers storage requirements and allows for efficient computation. Despite these advantages, BFP can be challenging when implemented in hardware optimized for smaller block sizes. Consequently, there is an ongoing interest in refining BFP formats.

### SUMMARY

One embodiment described herein is an artificial intelligence (AI) engine including a register file including a block floating point configured to be converted to a block size that aligns with hardware capabilities by dividing the block floating point into multiple sub-blocks and replicating an exponent of the block floating point for each of the multiple sub-blocks. In one example, the block floating point includes 32 elements and the multiple sub-blocks are 4 sub-blocks with 8 elements each. In another example, the block floating point includes 32 elements and the multiple sub-blocks are 2 sub-blocks with 16 elements each.

One embodiment described herein is a method including converting a block floating point stored in a register file of an artificial intelligence (AI) engine to a block size that aligns with hardware capabilities by dividing the block floating point into multiple sub-blocks and replicating an exponent of the block floating point for each of the multiple sub-blocks.

One embodiment described herein is a processor including one or more artificial intelligence (AI) engines, each AI engine including a register file having a block floating point configured to be converted to a block size that aligns with hardware capabilities by dividing the block floating point into multiple sub-blocks and replicating an exponent of the block floating point for each of the multiple sub-blocks.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a block floating point with a first number of integer elements or values, according to an example.

FIG. 2 illustrates transforming the block floating point with the first number of integer elements or values to a block floating point format having a second number of integer elements or values, according to an example.

FIG. 3 is a block diagram of an accelerator unit (AU) configured to execute workloads for applications running on a processing system, according to an example.

FIG. 4 illustrates a method for transforming block floating point values to other block floating point formats, according to an example.

FIG. 5 illustrates an artificial intelligence (AI) engine including a register file for storing block floating point elements or values, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

An AI engine or AI engine core is a specialized processing unit used to accelerate artificial intelligence (AI) and machine learning (ML) tasks. These AI engine cores are optimized for the computational requirements of AI workloads, which often involve extensive mathematical operations, large datasets, and high parallelism. AI engine cores feature architectures tailored to handle AI workloads. This may include optimized instruction sets, data paths, and memory hierarchies that facilitate efficient processing of matrix and vector operations found in neural networks. AI engine cores are used to perform many calculations simultaneously, leveraging data parallelism inherent in AI algorithms.

AI engine cores include multipliers. A multiplier is a digital circuit or device used to perform multiplication operations on numerical values, usually in binary form. A multiplier is a fundamental component in various computing systems, including processors, digital signal processors (DSPs), graphics processing units (GPUs), and AI accelerators. A multiplier takes two input values (operands) and produces a single output value that is the product of those operands.

Block floating-point (BFP) values are a type of numerical representation used to efficiently store and process data with a wide dynamic range in systems where precise floating-point arithmetic is too resource-intensive. In BFP, a block of numbers shares a common exponent, which helps reduce the storage and computational cost associated with individual floating-point exponents for each number.

Instead of each value having its own exponent (as in traditional floating-point), a block of values shares a single exponent. The exponent is chosen based on the largest value in the block, scaling all values relative to it. Each number within the block is stored with a mantissa, and the shared exponent applies a scale factor to these mantissas. This representation allows the block to cover a wide range of values but with less precision than individual floating-point representations. BFP reduces memory and computational overhead by not storing or computing separate exponents for each value.

Since all numbers share a common exponent, the dynamic range is constrained within each block, which can introduce quantization error. This trade-off is acceptable in applications where a minor loss in precision is permissible for gains in efficiency. BFP is particularly valuable in ML, where large matrices or vectors of values need to be processed quickly and efficiently. BFP allows high-throughput computation with lower power consumption and memory requirements. BFP thus offers a middle ground between fixed-point (where all values share the same exponent) and full floating-point precision, making it suitable for performance-sensitive applications that can tolerate minor precision loss.

In modern data processing applications, hardware increasingly supports BFP formats with smaller block sizes, such as 8 integer values per block. This configuration allows for efficient scaling with minimal precision loss, as smaller blocks tend to have values within a narrower dynamic range, making them easier to represent accurately under a single shared exponent. However, many legacy and intermediate systems use BFP formats that apply a single shared exponent across larger blocks, such as 32 integer values. This discrepancy presents a challenge when integrating new hardware that supports only smaller block sizes, as data encoded in a 32-value BFP format may need to be converted to multiple 8-value blocks to take full advantage of the newer hardware capabilities.

To address this compatibility issue, the example embodiments present a method to transform a 32-value BFP block into four smaller blocks of 8 values each, while preserving the original exponent. The conversion process involves dividing the original block of 32 integer values into four groups of 8 values, each retaining the same shared exponent as the original 32-block. This transformation maintains the scaling factor across all values, enabling the data to be processed by the new hardware without the need for recalculating the exponent for each sub-block. Retaining the original exponent also minimizes computational overhead, ensuring that the data remains compatible with precision-sensitive applications and avoiding the additional processing needed to dynamically adjust exponents.

Converting from a 32-value block to multiple 8-value blocks offers several benefits. First, smaller blocks improve compatibility with hardware architectures that optimize for data locality and memory efficiency by processing smaller data groups, such as 8-value blocks, within cache and register constraints. Second, dividing the data into smaller blocks can lead to higher processing efficiency in systems designed for parallel operations, as each 8-value block can be processed independently or in parallel, reducing latency and enhancing throughput. Additionally, this transformation minimizes quantization error by narrowing the range of values within each block, which can lead to greater numerical stability and more accurate results in applications with strict precision requirements. Overall, this approach facilitates seamless integration of legacy data formats into modern hardware environments, enabling efficient data processing while preserving precision and computational resources.

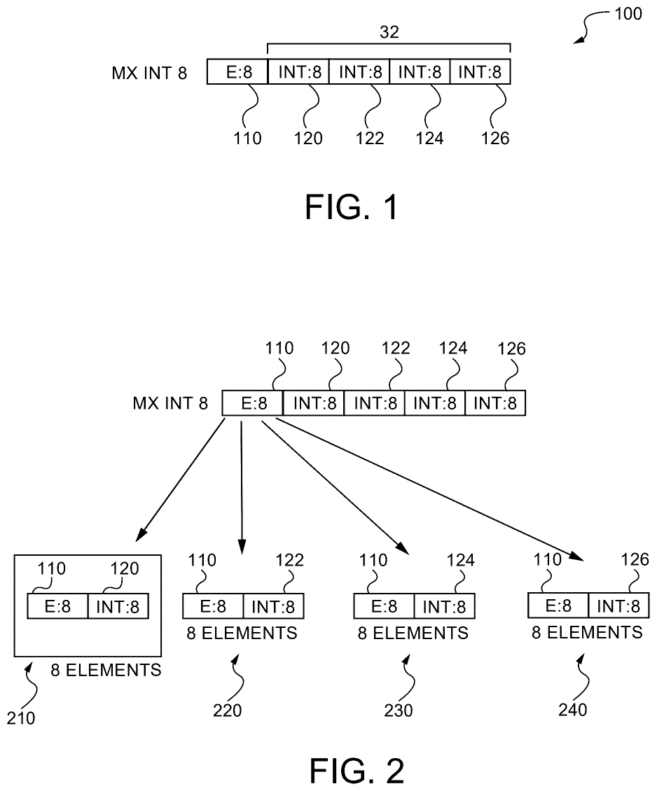

FIG. 1 illustrates a block floating point with a first number of integer elements or values, according to an example.

To convert a set of 32 floating-point values to a BFP format (e.g., to a block floating point 100), the maximum values are determined, the shared exponent is calculated, and the values are scaled to compute mantissas. In other words, the maximum absolute value within the 32 values in the block is determined. This maximum value determines the exponent so that no value in the block exceeds the representable range. Using the maximum value, an exponent is computed that brings it into the range representable by the chosen integer bit width (e.g., 32-bit). Each value in the block is then scaled by the shared exponent, converting it to an integer representation. By storing only one exponent per block of 32 values, the BFP reduces storage requirements compared to traditional floating-point formats, where each value has its own exponent.

The block floating point 100 includes a shared exponent 110 with 32 integer elements. The 32 integer elements are divided into, e.g., four blocks, that is, a first block 120 with 8 integer elements, a second block 122 with 8 integer elements, a third block 124 with 8 integer elements, and a fourth block 126 with 8 integer elements. The first block 120, the second block 122, the third block 124, and the fourth block 126 may be referred to as sub-blocks. The first sub-block may include integers [0-7], the second sub-block may include integers [8-15], the third sub-block may include integers [16-23], and the fourth sub-block may include integers [24-31].

The single shared exponent 110 represents the scaling factor for all integers within a sub-block. The single shared exponent 110 determines the range and precision of the numbers in that sub-block. Each integer within the block is stored as its mantissa (scaled value). The 32 integers are divided into, e.g., 4 sub-blocks, each with 8 integers. Each sub-block has its own shared exponent.

Many legacy and intermediate systems use BFP formats that apply a single shared exponent across larger blocks, such as 32 integer values. However, certain hardware supports BFP formats with smaller block sizes, such as 8 integer values per block. To address this compatibility issue, the example embodiments present a method to transform a 32-value BFP block into, e.g., four smaller blocks of 8 values each, while preserving the original exponent, as described below with reference to FIG. 2.

FIG. 2 illustrates transforming the block floating point with the first number of integer elements or values to a block floating point format having a second number of integer elements or values, according to an example.

To transform a 32-value BFP block into, e.g., four smaller blocks of 8 values each, while preserving the original exponent, the conversion process involves dividing the original block of 32 integer values into, e.g., four groups of 8 values, each retaining the same shared exponent as the original 32-block. This transformation maintains the scaling factor across all values, enabling the data to be processed by the new hardware without the need for recalculating the exponent for each sub-block.

In FIG. 2, the 32-value BFP block is divided into a first integer block 210, a second integer block 220, a third integer block 230, and a fourth integer block 240. The first integer block 210 includes 8 elements or values, the second integer block 220 includes 8 elements or values, the third integer block 230 includes 8 elements or values, and the fourth integer block 240 includes 8 elements or values. Each integer block includes the exponent 110.

The exponent 110 for each block or sub-block determines the scaling factor for all values in the block or sub-block. This is typically chosen based on the largest absolute value in the block to maximize precision and avoid overflow. Each of the 32 values in the block floating point 100 is represented by an integer (e.g., 32-bit) that acts as the mantissa. These integers represent the scaled-down versions of the original floating-point values.

Stated differently, the examples transform a BFP format from a block size of 32 to a block size of, e.g., 8 by dividing the original block into, e.g., four smaller blocks of 8 values each and replicating the exponent for each new block. The process starts with a BFP representation that has a single exponent scaling 32 integer values (mantissas). This original exponent is based on the largest absolute value within the block of 32 values. Then, the block of 32 is divided into four blocks of 8. Each group of 8 values now forms a new, smaller block or sub-block. After dividing the block of 32 into four blocks of 8, the same exponent 110 (from the original 32-block) is assigned to each of the four new 8-value blocks or sub-blocks. By copying the exponent 110, all four blocks or sub-blocks maintain the same scaling as the original 32-block, preserving the overall dynamic range.

By reducing the block size (32-block), each smaller block or sub-block of 8 values has less variation in magnitude compared to the original 32-block. This leads to fewer rounding errors and less quantization noise when values are closer in range. Using smaller blocks mitigates the impact of extreme values skewing the scaling of the entire block, preserving more detail in each group. With four smaller blocks, it is possible, optionally, to recalculate or adjust the exponent for each block if needed. This allows for better dynamic range control, especially if values in different sections of the original block vary significantly. For hardware architectures optimized for smaller blocks (e.g., processing units handling blocks of 8 values), the new block size of 8 fits well and enhances processing efficiency. Dividing into 8-value blocks can also make vectorized operations more straightforward, particularly on platforms that process data in smaller chunks. Smaller blocks can result in more localized memory access patterns, which may reduce cache misses in applications where data locality is beneficial. Dividing data into, e.g., 8-value blocks can improve cache efficiency compared to accessing all 32 values at once.

In another example, the 32-value BFP block can be converted or transformed into, e.g., two smaller blocks of 16 values each, while preserving the original exponent, the conversion process involves dividing the original block of 32 integer values into, e.g., two groups of 16 values, each retaining the same shared exponent as the original 32-block. Since the exponent is preserved, the numerical values represented by the 16-value blocks are identical to the corresponding subset of the original block. The two smaller blocks can be processed independently by hardware units (e.g., GPUs) optimized for 16-value blocks. Both blocks align with the hardware's or GPUs processing capabilities while maintaining the numerical integrity of the original data. Partitioning into smaller blocks can also align better with memory and cache systems including GPUs optimized for 16-value operations, improving data locality and reducing access latency. As such, smaller blocks reduce the complexity of data transfers, enabling more efficient streaming and reduced memory bandwidth usage.

In a BFP format, block size refers to the number of values that share a common exponent within a block or sub-block. Block size is a valuable parameter because it influences both memory efficiency and numerical accuracy. The choice of block size can vary widely depending on the application requirements, system constraints, and the acceptable precision loss. Small blocks may include 2 to 8 values per block, medium blocks may include 16 to 32 values per block, and large blocks may include 64 or more values per block.

Smaller blocks mean fewer values share the same exponent, leading to higher accuracy within each block. This configuration reduces quantization error as the values are likely to have similar magnitudes. Since each block has its own exponent, smaller block sizes use more exponent storage overall and can increase computational complexity.

Medium-sized blocks strike a balance between precision and memory efficiency. Medium-sized blocks offer a reasonable compromise between accuracy and memory usage by minimizing the number of shared exponents while maintaining efficient storage. Exponent storage requirements are reduced relative to small blocks, allowing better memory efficiency without drastic precision loss. Such medium-sized blocks can be used in ML applications, especially when processing batches of data. AI applications, particularly neural networks, often use 16, 32, or 64 values per block to optimize memory usage and performance.

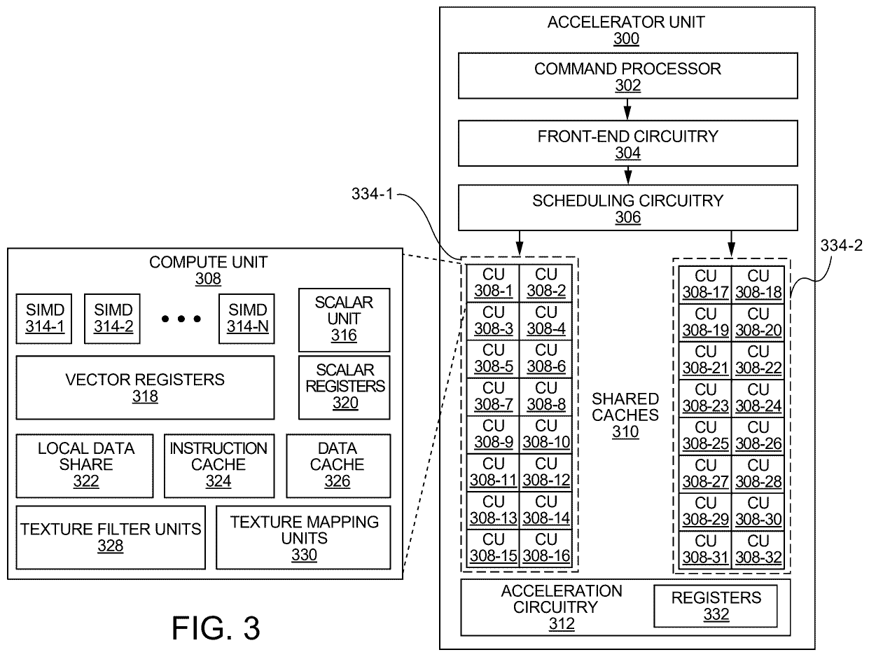

Moreover, some processors or accelerators, as described below with reference to FIG. 3, are optimized for certain block sizes (e.g., 8 or 16 or 32 values). In these cases, choosing a block size that aligns with hardware capabilities can enhance efficiency. In particular, FIG. 3 below can be optimized for a block size of 8. As such, it would be beneficial to transform a 32-value BFP block into, e.g., four smaller blocks of 8 values each, while preserving the original exponent, as described in detail with reference to FIG. 2.

As such, BFP arithmetic is widely used in processors and GPUs for efficient computation with high dynamic range and reduced storage overhead. When working with a 32-value BFP, transforming it into, e.g., four smaller blocks of 8 values each aligns with the hardware's architecture, which is optimized for blocks of 8 values. This transformation allows the hardware to efficiently execute parallelized and pipelined computations while preserving numerical precision and range. When implemented on processors or GPUs (e.g., FIG. 3), the processors or GPUs are optimized to perform parallelized operations on 8-element mantissas within a block and handle smaller shared exponents, reducing computational overhead. Dividing the 32-value BFP into, e.g., 8-value blocks ensures better memory alignment with the hardware's architecture, reducing latency and improving cache performance. The 4 smaller blocks allow computations to be executed independently in parallel pipelines or on separate cores, maximizing throughput. As such, GPUs and processors with fixed-size blocks (e.g., 8 values) achieve peak efficiency when data aligns with their architecture and smaller blocks allow for faster computations due to reduced exponent alignment overhead. Enhanced precision can also be achieved as each block has its own shared exponent, reducing the quantization error that occurs when using a single shared exponent for all 32 values. Further, hardware optimized for smaller blocks reduces unnecessary computation and memory overhead, leading to lower power usage.

In applications where the BFP size is unclear or varies depending on the operation or workload, configuring the hardware for the smallest block size (e.g., 8-value blocks) provides flexibility and simplicity. This approach allows for easier handling of certain use cases, such as when the exponent needs to be replicated, without significantly compromising performance or precision.

Using an 8-value block size minimizes the granularity of computations. It allows finer control over data representation, which is useful in diverse or dynamic workloads where data characteristics may vary. In scenarios where the same exponent applies to multiple blocks, replication ensures uniform scaling across those blocks. This avoids computational overhead associated with determining separate exponents for every small block.

Starting with smaller block sizes allows the system to scale to larger configurations if needed, by grouping multiple small blocks. For example, four 8-value blocks can be treated as a single 32-value block with a shared exponent if demanded by the application. Stated differently, starting with smaller blocks allows the hardware to scale dynamically as needed. For instance, if a workload later determines that larger block sizes (e.g., 16 or 32 values) are more efficient, the system can aggregate smaller blocks. Conversely, remaining at 8-value blocks ensures compatibility with the smallest possible dataset.

Thus, in operation, the hardware processes data in blocks of 8 elements at a time. Operating on smaller blocks ensures minimal granularity and provides greater flexibility in adapting to varying data sizes or computational requirements. While the hardware processes data in blocks of 8, it can read larger blocks (16 or 32 elements) directly from the memory. When reading larger blocks, a single exponent value can be replicated across multiple 8-element sub-blocks. This reduces storage requirements for the exponent, as only one is needed per larger block, improving memory efficiency.

Moreover, the hardware also allows conversion from floating-point to BFP during write operations. This may be configurable in, e.g., three modes. The first mode is in 8-element blocks having the finest granularity, where each block gets its own exponent. The second mode is in 16-element blocks, where two 8-element sub-blocks share the same exponent. The third mode is in 32-element blocks, where four 8-element sub-blocks share the same exponent. In the writing operation, the mechanism may include operations such as converting each floating-point value in the block to the nearest representable value in the BFP format, determining a single exponent for the entire block (or sub-blocks), and scaling all the values in the block to share this exponent.

In summary, a BFP format usually includes a shared exponent that applies to a group of numbers (the “block”) and a set of integer mantissas representing scaled values. This approach balances precision and efficiency by reducing the storage requirements for exponents while maintaining a reasonable dynamic range for computations. In this standard format, the shared exponent provides a common scaling factor for all elements in the block, and the mantissas represent the actual data values. However, in other examples, the BFP format is not restricted to integer mantissas with a shared exponent. The flexibility of BFP enables its extension to alternative number representations within the block. Instead of using integer mantissas, elements in the block may themselves be in narrow floating point formats, such as FP4 or FP8. These formats encode each element with its own small-scale exponent and mantissa, providing a finer granularity of representation.

FP4 is a 4-bit floating point that has minimal storage requirements per element and is suitable for applications where high precision is unnecessary, such as low-resolution image processing or approximate computations in AI/ML. FP8 is an 8-bit floating point), which offers a balance between storage efficiency and precision and is widely adopted in ML, where FP8 enables efficient training and inference with minimal loss in accuracy. These formats provide a limited dynamic range and precision for each value while maintaining a compact size. When used within a BFP context, narrow formats can enhance precision for datasets where integer-based scaling leads to quantization errors. For example, FP8 may be beneficial in neural network training where the precision of activations and gradients significantly impacts convergence.

Expanding the BFP framework to include narrow floating-point formats like FP4 and FP8 offers an alternative to integer-mantissa representations. These formats are advantageous in scenarios where precision and dynamic range are more critical than absolute storage efficiency. By accommodating both integer and narrow floating-point formats, the BFP model becomes more versatile, catering to diverse application domains ranging from resource-constrained embedded systems to high-performance AI/ML accelerators. The choice between integer-based and narrow floating-point BFP formats ultimately depends on the specific trade-offs in storage, precision, and computational complexity demanded by the target application.

FIG. 3 is a block diagram of an accelerator unit (AU) configured to execute workloads for applications running on a processing system, in accordance with some embodiments.

FIG. 3 presents an AU 300 configured to execute workloads for one or more applications running on a processing system. These applications include, for example, compute applications, graphics applications, or both each configured to issue respective series of instructions, also referred to herein as “threads,” to a central processing unit (CPU) of the processing system. Compute applications, when executed by a processing system, cause the processing system to perform one or more computations, such as machine-learning, neural network, high-performance computing, or databasing computations. Further, graphics applications, when executed by a processing system, cause the processing system to render a scene including one or more graphics objects and, as an example, output the scene on a display. The instructions issued to the CPU from these applications, for example, include groups of threads, also referred to herein as “workgroups,” to be executed by AU 300. To perform these workgroups, AU 300 includes one or more vector processors, coprocessors, graphics processing units (GPUs), general-purpose GPUs, non-scalar processors, highly parallel processors, artificial intelligence (AI) processors, inference engines, AI engines, AI engine cores, machine-learning processors, or any combination thereof. As an example, AU 300 includes one or more command processors 302, front-end circuitry 304, scheduling circuitry 306, compute units 308, shared caches 310, and acceleration circuitry 312.

A command processor 302 of AU 300 is configured to receive, from the CPU, a command stream indicating one or more workgroups to be executed. As an example, based on a compute application running on the processing system, the command processor 302 receives a command stream indicating workgroups that involve compute operations such as matrix multiplication, addition, subtraction, and the like to be performed. As another example, based on a graphics application running on the processing system, the command processor 302 receives a command stream indicating workgroups that include draw calls for a scene to be rendered. After receiving a command stream, the command processor 302 parses the command stream and issues respective instructions of the indicated workgroups to front-end circuitry 304, scheduling circuitry 306, or both. As an example, based on a command stream from a graphics application, the command processor 302 issues one or more draw calls to front-end circuitry 304 that includes one or more vertex shaders, polygon list builders, and the like. From the instructions issued from the command processor 302, front-end circuitry 304 is configured to position geometry objects in a scene, assemble primitives in a scene, cull primitives, perform visibility passes for primitives in a scene, generate visible primitive lists for a scene, or any combination thereof. For example, based on a set of draw calls received from a command processor 302, front-end circuitry 304 determines a list of primitives to be rendered for a scene. After determining a list of primitives to be rendered for a scene, the front-end circuitry 304 issues one or more draw calls (e.g., a workgroup) associated with the primitives in the list of primitives to scheduling circuitry 306.

Based on the instructions of the workgroups received from a command processor 302, front-end circuitry 304, or both, scheduler circuitry 306 is configured to provide data indicating threads (e.g., operations for these threads) to be executed for these workgroups to one or more compute units 308. Each compute unit 308 is configured to support the concurrent execution of two or more threads of a workgroup. For example, each compute unit 308 is configured to concurrently execute a predetermined number of threads referred to herein as a “wavefront.” Based on the size of the wavefront of a compute unit 308, scheduler circuitry 306 schedules one or more groups of threads of the workgroup, also referred to herein as “waves,” to be executed by the compute unit 308. As an example, scheduler circuitry 306 first updates one or more registers of a compute unit 308 such that the compute unit 308 is configured to execute a first group of waves of the workgroup. After the compute unit 308 has executed the first group of waves, scheduler circuitry 306 updates one or more registers of the compute unit 308 to schedule a second group of waves of the workgroup to be executed by the compute unit 308. To execute these waves, each compute unit is connected to one or more shared caches 310 that each include a volatile memory, non-volatile memory, or both accessible by one or more compute units 308. These shared caches 310, for example, are configured to store data (e.g., register files, values, operands, instructions, variables) used in the execution of one or more waves, data resulting from the performance of one or more waves, or both. Because a shared cache 310 is accessible by two or more compute units 308, a first compute unit 308 is enabled to provide results from the execution of a first wave to a second compute unit 308 executing a second wave. Though the example embodiment presented in FIG. 3 shows AU 300 as including 32 compute units (308-1 to 308-32), in other implementations, AU 300 can include any number of compute units 308.

Each compute unit 308 includes one or more single instruction, multiple data (SIMD) units 314, a scalar unit 316, vector registers 318, scalar registers 320, local data share 322, instruction cache 324, data cache 326, texture filter units 328, texture mapping units 330, or any combination thereof. A SIMD unit 314 (e.g., a vector processor) is configured to concurrently perform multiple instances of the same operation for a wave. For example, a SIMD unit 314 includes two or more lanes each including an arithmetic logic unit (ALU) and each configured to perform the same operation for the threads of a wave. Though the example embodiment presented in FIG. 3 shows a compute unit 308 including three SIMD units (314-1, 314-2, 314-N) representing an N number of SIMD units, in other implementations, a compute unit 308 can include any number of SIMD units 314. Further, as an example, the size of a wavefront supported by AU 300 is based on the number of SIMD units 314 included in each compute unit 308. To determine the operations performed by the SIMD units 314, each compute unit 308 includes vector registers 318 formed from one or more physical registers of AU 300. These vector registers 318 are configured to store data (e.g., operands, values) used by the respective lanes of the SIMD units 314 to perform a corresponding operation for the wave. Additionally, each compute unit 308 includes a scalar unit 316 configured to perform scalar operations for the wave. As an example, the scalar unit 316 includes an ALU configured to perform scalar operations. To support the scalar unit 316, each compute unit 308 includes scalar registers 320 formed from one or more physical registers of accelerator unit 300. These scalar registers 320 store data (e.g., operands, values) used by the scalar unit 316 to perform a corresponding scalar operation for the wave.

Further, each compute unit 308 includes a local data share 322 formed from a volatile memory (e.g., random-access memory) accessible by each SIMD unit 314 and the scalar unit 316 of the compute unit 308. That is to say, the local data share 322 is shared across each wave concurrently executing on the compute unit 308. The local data share 322 is configured to store data resulting from the execution of one or more operations for one or more waves, data (e.g., register files, values, operands, instructions, variables) used in the execution of one or operations for one or more waves, or both. As an example, the local data share 322 is used as a scratch memory to store results necessary for, aiding in, or helpful for the performance of one or more operations by one or more SIMD units 314. The instruction cache 324 of a compute unit 308, for example, includes a volatile memory, non-volatile memory, or both configured to store the instructions to be executed for one or more waves to be executed by the compute unit 308. Further, the data cache 326 of a compute unit 308 includes a volatile memory, non-volatile memory, or both configured to store data (e.g., register files, values, operands, variables) used in the execution of one or more waves by the compute unit 308. The instruction cache 324, data cache 326, shared caches 310, and a system memory, for example, are arranged in a hierarchy based on the respective sizes of the caches. As an example, based on such a cache hierarchy, a compute unit 308 first requests data from a controller of a corresponding data cache 326. Based on the data not being in the data cache 326, the data cache 326 requests the data from a shared cache 310 at the next level of the cache hierarchy. The caches then continue in this way until the data is found in a cache or requested from the system memory, at which point, the data is returned to the compute unit 308. Additionally, each compute unit 308 includes one or more texture mapping units 330 each including circuitry configured to map textures to one or more graphics objects (e.g., groups of primitives) generated by the compute units 308. Further, each compute unit 308 includes one or more texture filter units 328 each having circuitry configured to filter the textures applied to the generated graphics objects. For example, the texture filter units 328 are configured to perform one or more magnification operations, anti-aliasing operations, or both to filter a texture.

Additionally, to help perform instructions for one or more workgroups, AU 300 includes acceleration circuitry 312. Such acceleration circuitry 312 includes hardware (e.g., fixed-function hardware) configured to execute one or more instructions for one or more workgroups. As an example, acceleration circuitry 312 includes one or more instances of fixed function hardware configured to encode frames, encode audio, decode frames, decode audio, display frames, output audio, perform matrix multiplication, or any combination thereof. To schedule instructions for execution on such hardware, scheduling circuitry 306 is configured to update one or more physical registers 332 of AU 300 associated with the hardware. In some cases, AU 300 includes one or more compute units 308 grouped into one or more shader engines 334. Referring to the embodiment presented in FIG. 3, for example, AU 300 includes compute units 308-1 to 308-16 grouped in a first shader engine 334-1 and compute units 308-17 to 308-32 grouped in a second shader engine 334-2. Such shader engines 334, for example, are configured to execute one or more workgroups (e.g., one or more compute kernels) for an application and include one or more compute units 308, graphics processing hardware (e.g., primitive assemblers, rasterizers), one or more shared caches 310, render backends, or any combination thereof. Though the embodiment presented in FIG. 3 shows AU 300 as including two shader engines (334-1, 334-2), in other implementations, AU 300 can include any number of shader engines (334-1, 334-2).

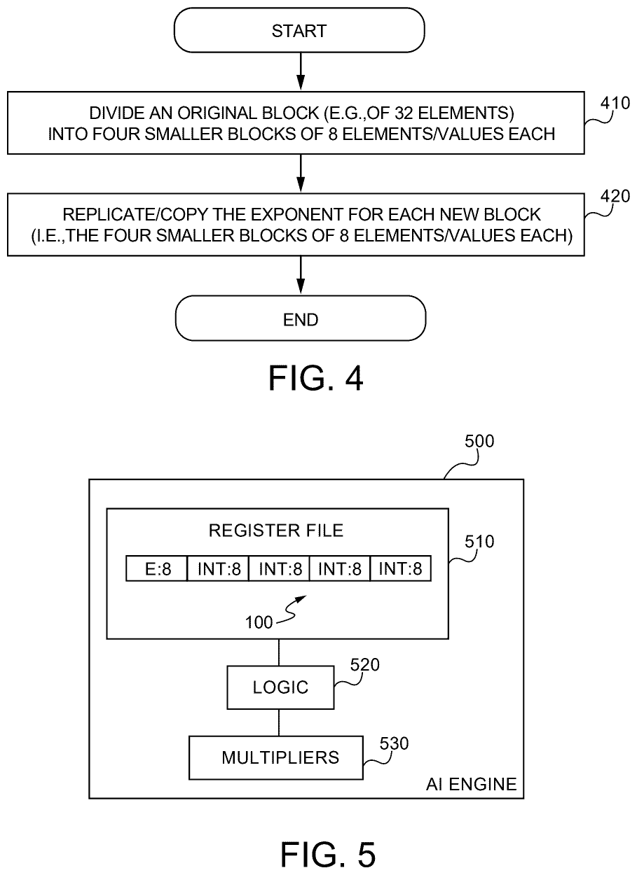

FIG. 4 illustrates a method for transforming block floating point values to other block floating point formats, according to an example.

At 410, an original block (e.g., of 32 elements) is divided into, e.g., four smaller blocks of 8 elements/values each. Each group of 8 values now forms a new, smaller block or sub-block.

At 420, the exponent for each new block is replicated or copied (i.e., the four smaller blocks of 8 elements/values each). By copying the exponent, all four blocks will maintain the same scaling as the original 32-block, preserving the overall dynamic range. In other words, this ensures that the scaling factor remains consistent across all blocks. Each integer in a smaller block represents the same actual value as it did in the original 32-value block because the scaling factor is unchanged. So the entire data set (all four blocks) are scaled relative to the same reference (i.e., the exponent 110). If the smaller blocks were to be recombined, they would precisely reconstruct the original numerical values. This transformation maintains the scaling factor across all values, enabling the data to be processed by the new hardware without the need for recalculating the exponent for each sub-block.

FIG. 5 illustrates an artificial intelligence (AI) engine including a register file for storing block floating point elements or values, according to an example.

The AI engine 500 includes a register file 510 having the block floating point 100. The register file 510 communicates with one or more multipliers 530 via logic 520. The register file 510 includes the block floating point 100 that is converted to a block size that aligns with hardware capabilities by dividing the block floating point 100 into multiple sub-blocks (e.g., 2 or 4 sub-blocks) and replicating the exponent 110 of the block floating point 100 for each of the multiple sub-blocks.

The register file 510 in the AI engine 500 is a small, high-speed storage area that holds a set of registers used for temporarily storing data during computation. The register file 510 stores intermediate values and operands that are actively used during computations, allowing for quick access by the processing units. The register file 510 can accommodate various data types (e.g., integers, floating-point numbers, fixed-point representations, block floating points, etc.) used in AI computations. Many AI engine cores support mixed precision to optimize performance and resource utilization.

The internal logic 520 of the AI engine 500 enables communication between the register file 510 and the one or more multipliers 530 for transformation between block floating-point formats (e.g., 32-value to 8-value).

In operation, the register file 510 temporarily holds data during processing. The register file 510 facilitates efficient data movement to/from the one or more multipliers 530. In BFP, a block of numbers shares a common exponent, optimizing representation for values of similar magnitudes. The AI engine 500 identifies the block's shared exponent using reduction operations (e.g., finding the maximum absolute value). This shared exponent is used during the transformation process. Regarding the internal logic 520 (or transformation logic), the scaling factor needed to transform a 32-bit BFP representation to an 8-bit BFP format is determined. The scaling factor is derived by calculating the difference in bit widths and adjusting for the dynamic range of the smaller format. The input BFP block may be normalized based on its current shared exponent to align the mantissas. This ensures no data overflow or underflow during precision reduction. Quantization may be performed by reducing the mantissa precision from 32 values to 8 values. Various rounding techniques (e.g., nearest neighbor, stochastic rounding) may be applied to minimize quantization error. Then, the shared exponent for the reduced precision format is adjusted to encode the new exponent for the 8-value block. The multipliers may perform scaled multiplications directly on normalized mantissas by using high-throughput multiply-accumulate (MAC) units to maintain precision during intermediate computations. For BFP transformations involving summations, accumulators manage intermediate precision and handle overflow.

Multipliers are fundamental in AI and computing. Multiplication is a fundamental operation in many computational tasks, such as convolution, matrix operations, and polynomial evaluations. In AI and ML, multipliers are heavily used for matrix-matrix and matrix-vector multiplications in tasks like neural network training and inference. Hardware multipliers are orders of magnitude faster and more energy-efficient than performing multiplication in software using basic arithmetic operations. Multipliers are used in multiply-accumulate (MAC) units, which are valuable for performing tensor operations in AI workloads. As such, a multiplier is an indispensable building block in digital systems and AI engines, enabling fast and efficient arithmetic operations.

In conclusion, the examples provide for a method to transform a 32-value BFP block into, e.g., four smaller blocks of 8 values each, while preserving the original exponent. The conversion process involves dividing the original block of 32 integer values into, e.g., four groups of 8 values, each retaining the same shared exponent as the original 32-block. The examples can also provide for a method to transform a 32-value BFP block into, e.g., two smaller blocks of 16 values each, while preserving the original exponent. The conversion process involves dividing the original block of 32 integer values into, e.g., two groups of 16 values, each retaining the same shared exponent as the original 32-block. This transformation maintains the scaling factor across all values, enabling the data to be processed by the new hardware without the need for recalculating the exponent for each sub-block. Retaining the original exponent also minimizes computational overhead, ensuring that the data remains compatible with precision-sensitive applications and avoiding the additional processing needed to dynamically adjust exponents.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An artificial intelligence (AI) engine comprising:
a register file including a block floating point configured to be converted to a block size that aligns with hardware capabilities by:
dividing the block floating point into multiple sub-blocks; and
replicating an exponent of the block floating point for each of the multiple sub-blocks.

2. The AI engine of claim 1, wherein the block floating point includes 32 elements and the multiple sub-blocks are 4 sub-blocks with 8 elements each.

3. The AI engine of claim 1, wherein the block floating point includes 32 elements and the multiple sub-blocks are 2 sub-blocks with 16 elements each.

4. The AI engine of claim 1, wherein each of the multiple sub-blocks is configured to maintain a same scaling as the block floating point.

5. The AI engine of claim 1, wherein the AI engine includes transformation logic that enables conversion of the block floating point to the block size that aligns with the hardware capabilities.

6. The AI engine of claim 1, wherein the AI engine includes one or more multipliers that supports conversion of the block floating point to the block size that aligns with the hardware capabilities.

7. The AI engine of claim 1, wherein each of the multiple sub-blocks is configured to have less variation in magnitude compared to the block floating point.

8. A method comprising:
converting a block floating point stored in a register file of an artificial intelligence (AI) engine to a block size that aligns with hardware capabilities by:
dividing the block floating point into multiple sub-blocks; and
replicating an exponent of the block floating point for each of the multiple sub-blocks.

9. The method of claim 8, wherein the block floating point includes 32 elements and the multiple sub-blocks are 4 sub-blocks with 8 elements each.

10. The method of claim 8, wherein the block floating point includes 32 elements and the multiple sub-blocks are 2 sub-blocks with 16 elements each.

11. The method of claim 8, wherein each of the multiple sub-blocks is configured to maintain a same scaling as the block floating point.

12. The method of claim 8, wherein the AI engine includes transformation logic that enables conversion of the block floating point to the block size that aligns with the hardware capabilities.

13. The method of claim 8, wherein the AI engine includes one or more multipliers that supports conversion of the block floating point to the block size that aligns with the hardware capabilities.

14. The method of claim 8, wherein each of the multiple sub-blocks is configured to have less variation in magnitude compared to the block floating point.

15. A processor comprising:
one or more artificial intelligence (AI) engines, each AI engine including a register file having a block floating point configured to be converted to a block size that aligns with hardware capabilities by:
dividing the block floating point into multiple sub-blocks; and
replicating an exponent of the block floating point for each of the multiple sub-blocks.

16. The processor of claim 15, wherein the processor is a graphics processing unit (GPU).

17. The processor of claim 15, wherein the block floating point includes 32 elements and the multiple sub-blocks are 4 sub-blocks with 8 elements each.

18. The processor of claim 15, wherein the block floating point includes 32 elements and the multiple sub-blocks are 2 sub-blocks with 16 elements each.

19. The processor of claim 15, wherein each of the multiple sub-blocks is configured to maintain a same scaling as the block floating point.

20. The processor of claim 15, wherein the AI engine includes transformation logic that enables conversion of the block floating point to the block size that aligns with the hardware capabilities.
